(19) United States
(12) Patent Application Publication
(10) Pub. No.: US 2021/0166641 A1
(43) Pub. Date: Jun. 3, 2021

(54) DISPLAY PANEL AND DISPLAY DEVICE

(71) Applicant: HUIZHOU CHINA STAR OPTOELECTRONICS TECHNOLOGY CO., LTD., Huizhou, Guangdong (CN)

(72) Inventor: Yuecu LIN, Huizhou (CN)

(73) Assignee: HUIZHOU CHINA STAR OPTOELECTRONICS TECHNOLOGY CO., LTD., Huizhou, Guangdong (CN)

(21) Appl. No.: 16/754,327

(22) PCT Filed: Jan. 7, 2020
(86) PCT No.: PCT/CN2020/070711

§ 371 Date: Apr. 7, 2020

(30) Foreign Application Priority Data
Nov. 29, 2019 (CN) 201911198204.X

(51) Int. Cl. G09G 3/36

(52) U.S. Cl. CPC G09G 3/3607; G09G 2300/0452

(57) ABSTRACT

A display panel and a display device provided by the present disclosure comprise a substrate comprising a plurality of pixel unit areas disposed in an array, and a plurality of pixel units respectively disposed in the plurality of pixel unit areas. Each pixel unit of the plurality of pixel units comprises an R sub-pixel, a G sub-pixel, and a B sub-pixel, wherein a proportion of area occupied by the B sub-pixel in each of the plurality of pixel unit areas is a, and a is greater than one-eighth and less than one-third. The display panel and the display device provided by the present disclosure can improve viewing angles displaying different skin colors.

### TECHNICAL FIELD

The present disclosure relates to the field of array substrate manufacturing, and in particular, to a display panel and a display device.

### BACKGROUND

In the field of liquid crystal displays, vertical alignment (VA) type display mode has viewing angle problems such as obvious color shift at wide viewing angles and whiteness. Therefore, concerning the viewing angle problems in VA type display mode, an eight-domain pixel design has been proposed to improve the viewing angles. In the eight-domain pixel design, pixels are divided into two parts, namely a main region and a sub-region. The main region and the sub-region are provided with different voltages and areas to display different grayscales, achieving an effect of improving the viewing angle through spatial mixing. However, viewing angle issues of displaying skin colors of different races are different.

Display modes in the prior art cannot solve viewing angle problems of displaying skin colors of different races.

### SUMMARY

Embodiments of the present disclosure provide a display panel and a display device, which can improve the viewing angles displaying different skin colors.

An embodiment of the present disclosure provides the display panel. The display panel comprises a substrate comprising a plurality of pixel unit areas disposed in an array, and a plurality of pixel units respectively disposed in the plurality of pixel unit areas. Each of the plurality of pixel units comprises an R sub-pixel, a G sub-pixel, and a B sub-pixel, wherein a proportion of area occupied by the B sub-pixel in each of the plurality of pixel unit areas is a, and ⅛<a<⅓.

An embodiment of the present disclosure provides the display device comprising a display panel. The display panel comprises a substrate comprising a plurality of pixel unit areas disposed in an array, and a plurality of pixel units respectively disposed in the plurality of pixel unit areas. Each of the plurality of pixel units comprises an R sub-pixel, a G sub-pixel, and a B sub-pixel, wherein a proportion of area occupied by the B sub-pixel in each of the plurality of pixel unit areas is a, and ⅛<a<⅓.

The display panel and the display device provided in the embodiments of the present disclosure comprise a substrate comprising a plurality of pixel unit areas disposed in an array, and a plurality of pixel units respectively disposed in the plurality of pixel unit areas. Each of the plurality of pixel units comprises an R sub-pixel, a G sub-pixel, and a B sub-pixel, wherein a proportion of area occupied by the B sub-pixel in each of the plurality of pixel unit areas is a, and ⅛<a<⅓. As the proportion of area of the B sub-pixel is reduced, an influence of the B grayscale on the viewing angle is reduced, thus greatly improving the viewing angles displaying different skin colors.

### BRIEF DESCRIPTION OF DRAWINGS

To describe the technical solutions of the embodiments of the present disclosure or in the prior art more clearly, the following briefly introduces the accompanying drawings used in the description of the embodiments of the present disclosure or in the prior art. Apparently, the accompanying drawings described below illustrate only some exemplary embodiments of the present disclosure, and persons skilled in the art may derive other drawings from the drawings without making creative efforts.

FIG. 1 is a structural diagram illustrating a display panel according to some embodiments of the present disclosure.

FIG. 2 is a structural diagram illustrating a display panel with another structure according to some embodiments of the present disclosure.

### DETAILED DESCRIPTION OF PREFERRED EMBODIMENTS

Reference will now be made in detail to embodiments, examples of which are illustrated in the accompanying drawings. Wherein, same or similar reference numbers always represent same or similar elements or elements with same or similar functions. The embodiments described with reference to the drawings are exemplary, and are just used for explaining the disclosure, not for limiting the disclosure.

In description of the disclosure, it should be understood that orientational or positional relationships represented by directional terms mentioned in the present disclosure, such as central, longitudinal, lateral, length, width, thickness, up, down, front, rear, left, right, vertical, horizontal, top, bottom, inside, outside, clockwise, anticlockwise, etc., are orientational or positional relationships based on the drawings, and are merely for the convenience of describing the present disclosure and simplifying the description, rather than indicating or implying that the device or element is intended to have a particular orientation, or is constructed and operated in a particular orientation, and therefore, should not be interpreted as a limitation of the application. In addition, terms such as “first” and “second” are used herein for purposes of description, and should not be interpreted as indication or implication of relative importance, or implied indication of a number of the technical features. Therefore, features limited by terms such as “first” and “second” can explicitly or impliedly include one or more than one of these features. In description of the disclosure, “a plurality of” means two or more than two, unless otherwise specified.

In the description of the present disclosure, it should be understood that, unless specified or limited otherwise, the terms “mounted,” “connected,” “coupled,” “fixed” and the like are used broadly, and may be, for example, fixed connections, detachable connections, or integral connections; may also be mechanical or electrical connections; may also be direct connections or indirect connections via intervening structures; may also be inner communications of two elements, which can be understood by those skilled in the art according to specific situations.

In the present disclosure, unless specified or limited otherwise, a structure in which a first feature is “on” or “below” a second feature may include an embodiment in which the first feature is in direct contact with the second feature, and may also include an embodiment in which the first feature and the second feature are not in direct contact with each other, but are contacted via an additional feature formed therebetween. Furthermore, a first feature “on,” “above,” or “on top of” a second feature may include an embodiment in which the first feature is right or obliquely “on,” “above,” or “on top of” the second feature, or just means that the first feature is at a height higher than that of the second feature; while a first feature “below,” “under,” or “on bottom of” a second feature may include an embodiment in which the first feature is right or obliquely “below,” “under,” or “on bottom of” the second feature, or just means that the first feature is at a height lower than that of the second feature.

Various embodiments and examples are provided in the following description to implement different structures of the present disclosure. In order to simplify the present disclosure, certain elements and settings will be described. However, these elements and settings are only by way of example and are not intended to limit the present disclosure. In addition, reference numerals may be repeated in different examples in the present disclosure. This repeating is for the purpose of simplification and clarity and does not refer to relations between different embodiments and/or settings. Furthermore, examples of different processes and materials are provided in the present disclosure. However, it would be appreciated by those skilled in the art that other processes and/or materials may be also applied.

In the present disclosure, although characteristic RGB grayscale values of skin colors of different races are different, it can be found that B grayscale is the lowest among the RGB grayscale values of skin colors of different races. Meanwhile, color washout and color shift at wide viewing angles displaying different skin colors are usually caused by the B grayscale. Therefore, based on the above characteristics, the present disclosure proposes to change an arrangement of original RGB sub-pixels to increase a proportion of B sub-pixels, thus greatly improving viewing angle performance of displaying different skin colors. Skin colors of different races have different characteristic RGB grayscale values. For example, Asians' characteristic RGB grayscale value is around 133/101/75, and Asians' characteristic RGB grayscale value is around 195/156/129. It can be seen from the summary of skin color characteristics of different races that the B grayscale is usually the lowest. The lower the grayscale is, the flatter liquid crystals actually lie. Therefore, the greater the And difference between the liquid crystals in the front view and in the side view is, the worser the viewing angle is. A main reason why IPS liquid crystals have good viewing angles is that the liquid crystals are nearly lying flat, so the viewing angles particularly stand out. In addition, after an adjustment of white balance, the B grayscale corresponding to a picture with skin color is further reduced, thus making the viewing angles displaying different skin colors worser. If the B grayscale corresponding to the picture with skin color can be improved, the viewing angles displaying different skin colors can be improved naturally. Therefore, in view of the above problems, the present disclosure provides a way to increase the proportion of B sub-pixels in all sub-pixels based on the arrangement of ordinary RGB sub-pixels, so as to greatly improve the B grayscale corresponding to the picture with skin color and effectively improve the viewing angles of pictures with skin colors.

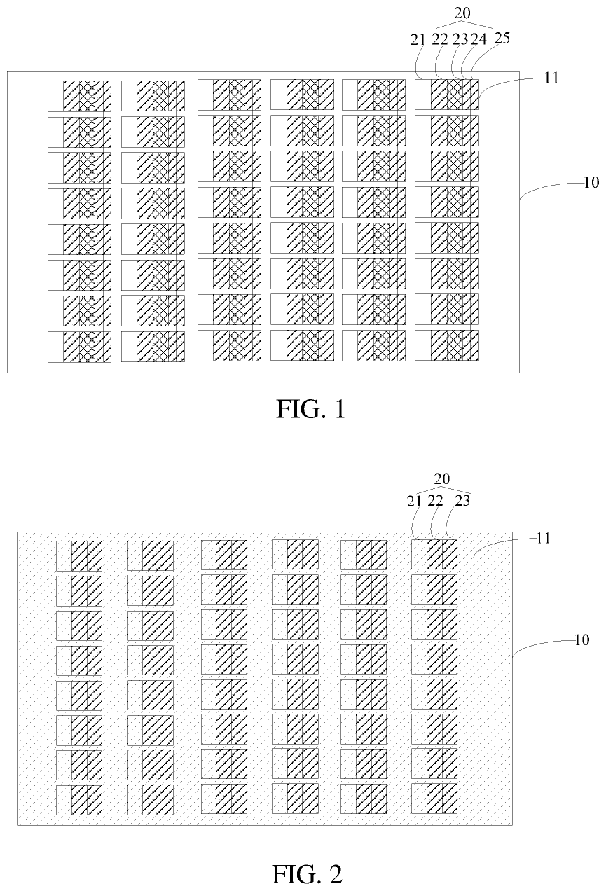

Please refer to FIG. 1, which is a structural diagram illustrating a display panel according to some embodiments of the present disclosure. The display panel comprises a substrate 10 and a plurality of pixel units 20 disposed on the substrate 10. Of course, the substrate 10 is also provided with a corresponding display driving circuit to drive the plurality of pixel units 20 to emit light.

Wherein, the substrate 10 comprises a plurality of pixel unit areas 11 disposed in an array, and the plurality of pixel units 20 are respectively disposed in the plurality of pixel unit areas 11. Each of the plurality of pixel units 20 comprises an R sub-pixel, a G sub-pixel, and a B sub-pixel, wherein a proportion of area occupied by the B sub-pixel in each of the plurality of pixel unit areas 11 is a, and ⅛<a<⅓.

Wherein, an area occupied in each of the plurality of pixel unit areas by the R sub-pixel is same as the G sub-pixel. The proportion of area occupied by the B sub-pixel is ¼, and respective proportions of area occupied by the R sub-pixel and the G sub-pixel in each of the plurality of pixel unit areas are ⅜. Each of the pixel unit areas comprises a first sub-area 21, a second sub-area 22, a third sub-area 23, a fourth sub-area 24, and a fifth sub-area 25 sequentially arranged side by side. The R sub-pixel is disposed in the first sub-area 21 and the fourth sub-area 24, the G sub-pixel is disposed in the second sub-area 22 and the fifth sub-area 25, and the B sub-pixel is disposed in the third sub-area 23.

In some embodiments, the first sub-area 21, the second sub-area 22, the third sub-area 23, the fourth sub-area 24, and the fifth sub-area 25 are rectangular. Proportions of area respectively occupied by the first sub-area 21 and the second sub-area 22 are ⅓, a proportion of area occupied by the third sub-area 23 is ¼, and proportions of area respectively occupied by the fourth sub-area 24 and the fifth sub-area 25 are 1/24.

Referring to FIG. 2, in some embodiments, each of the pixel unit areas comprises a first sub-area 21, a second sub-area 22, and a third sub-area 23 sequentially arranged side by side. The R sub-pixel is disposed in the first sub-area 21, the G sub-pixel is disposed in the second sub-area 22, and the B sub-pixel is disposed in the third sub-area 23. An area of the third sub-area 23 is less than an area of the first sub-area 21 and an area of the second sub-area 22, respectively. That is, in a single pixel unit, the area of the third sub-area 23 is respectively less than the area of the second sub-area 22 and the area of the first sub-area 21.

In some embodiments, an area of the first sub-area 21 is equal to an area of the second sub-area 22.

In some embodiments, a proportion of area occupied by the first sub-area 21 in each of the plurality of pixel unit areas is ⅜, a proportion of area occupied by the second sub-area 22 in each of the plurality of pixel unit areas is ⅜, and a proportion of area occupied by the third sub-area 23 in each of the plurality of pixel unit areas is ¼.

For example, during actual usage processes, display modes can be switched between a multi-person scene and a scene without people. For example, when the main display target is human, a skin color display mode can be adopted. When the main display target is scenery, a non-skin color display mode can be adopted to improve display quality and user experience.

An embodiment of the present disclosure further provides a display device comprising a display panel in any of the above embodiments.

Although characteristic RGB grayscale values of skin colors of different races are different, it can be found that the B grayscale is the lowest among the RGB grayscale values of skin colors of different races. Meanwhile, problems of color washout and color shift of viewing angles displaying different skin colors are usually caused by the B grayscale. Therefore, based on the above characteristics, the present disclosure proposes to change the arrangement of original RGB sub-pixels to decrease the proportion of B sub-pixels, thus greatly improving viewing angle performance of displaying different skin colors.

The display device and the display panel provided in the embodiments of the present disclosure comprise a substrate comprising a plurality of pixel unit areas disposed in an array, and a plurality of pixel units respectively disposed in the plurality of pixel unit areas. Each of the plurality of pixel units comprises an R sub-pixel, a G sub-pixel, and a B sub-pixel, wherein a proportion of area occupied by the B sub pixel in each of the plurality of pixel unit areas is a, and ⅛<a<⅓. As the proportion of area of the B sub-pixel is reduced, an influence of the B grayscale on the viewing angle is reduced, thus greatly improving the viewing angles of displaying different skin colors.

In conclusion, although the present disclosure has been disclosed in the above preferred embodiments, the above preferred embodiments do not intend to limit the present disclosure. Various modifications and changes may be made by ordinary person skilled in the art without departing from the spirit and scope of this application. Therefore, the scope of protection of this application is subject to the scope defined by the claims.

1. A display panel, comprising:
a substrate comprising a plurality of pixel unit areas disposed in an array; and
a plurality of pixel units respectively disposed in the plurality of pixel unit areas, wherein each of the plurality of pixel units comprises an R sub-pixel, a G sub-pixel, and a B sub-pixel; and
wherein a proportion of area occupied by the B sub-pixel in each of the plurality of pixel unit areas is ¼, and proportions of areas occupied by the R sub-pixel and the G sub-pixel in each of the plurality of pixel unit areas are respectively ⅜ and ⅜.

2. (canceled)

3. (canceled)

4. The display panel as claimed in claim 1, wherein each of the plurality of pixel unit areas comprises a first sub-area, a second sub-area, a third sub-area, a fourth sub-area, and a fifth sub-area sequentially arranged side by side, the R sub-pixel is disposed in the first sub-area and the fourth sub-area, the G sub-pixel is disposed in the second sub-area and the fifth sub-area, and the B sub-pixel is disposed in the third sub-area.

5. The display panel as claimed in claim 4, wherein the first sub-area, the second sub-area, the third sub-area, the fourth sub-area, and the fifth sub-area are rectangular, proportions of area respectively occupied by the first sub-area and the second sub-area are ⅓, a proportion of area occupied by the third sub-area is ¼, and proportions of area respectively occupied by the fourth sub-area and the fifth sub-area are 1/24.

6. The display panel as claimed in claim 1, wherein each of the plurality of pixel unit areas comprises a first sub-area, a second sub-area, and a third sub-area sequentially arranged side by side, the R sub-pixel is disposed in the first sub-area, the G sub-pixel is disposed in the second sub-area, and the B sub-pixel is disposed in the third sub-area.

7. The display panel as claimed in claim 6, wherein an area of the third sub-area is less than an area of the first sub-area and an area of the second sub-area, respectively.

8. The display panel as claimed in claim 6, wherein an area of the first sub-area is equal to an area of the second sub-area.

9. The display panel as claimed in claim 6, wherein a proportion of area occupied by the first sub-area in each of the plurality of pixel unit areas is ⅜, a proportion of area occupied by the second sub-area in each of the plurality of pixel unit areas is ⅜, and a proportion of area occupied by the third sub-area in each of the plurality of pixel unit areas is ¼.

10. A display device comprising a display panel, the display panel comprising:
a substrate comprising a plurality of pixel unit areas disposed in an array;
a plurality of pixel units respectively disposed in the plurality of pixel unit areas, wherein each of the plurality of pixel units comprises an R sub-pixel, a G sub-pixel, and a B sub-pixel; and
wherein a proportion of area occupied by the B sub-pixel in each of the plurality of pixel unit areas is ¼, and proportions of areas occupied by the R sub-pixel and the G sub-pixel are respectively ⅜ and ⅜.

11. (canceled)

12. (canceled)

13. The display device as claimed in claim 10, wherein each of the plurality of pixel unit areas comprises a first sub-area, a second sub-area, a third sub-area, a fourth sub-area, and a fifth sub-area sequentially arranged side by side, the R sub-pixel is disposed in the first sub-area and the fourth sub-area, the G sub-pixel is disposed in the second sub-area and the fifth sub-area, and the B sub-pixel is disposed in the third sub-area.

14. The display device as claimed in claim 13, wherein the first sub-area, the second sub-area, the third sub-area, the fourth sub-area, and the fifth sub-area are rectangular, proportions of area respectively occupied by the first sub-area and the second sub-area are ⅓, a proportion of area occupied by the third sub-area is ¼, and proportions of area respectively occupied by the fourth sub-area and the fifth sub-area are 1/24.

15. The display device as claimed in claim 10, wherein each of the plurality of pixel unit areas comprises a first sub-area, a second sub-area, and a third sub-area sequentially arranged side by side, the R sub-pixel is disposed in the first sub-area, the G sub-pixel is disposed in the second sub-area, and the B sub-pixel is disposed in the third sub-area.

16. The display device as claimed in claim 15, wherein an area of the third sub-area is less than an area of the first sub-area and an area of the second sub-area, respectively.

17. The display device as claimed in claim 15, wherein an area of the first sub-area is equal to an area of the second sub-area.

18. The display device as claimed in claim 15, wherein a proportion of area occupied by the first sub-area in each of the plurality of pixel unit areas is ⅜, a proportion of area occupied by the second sub-area in each of the plurality of pixel unit areas is ⅜, and a proportion of area occupied by the third sub-area in each of the plurality of pixel unit areas is ¼.
